(19) United States
(12) Patent Application Publication
(10) Pub. No.: US 2002/0062288 A1
(43) Pub. Date: May 23, 2002

(54) Server and method for managing use of software run by client

(75) Inventor: Tsukasa Ooishi, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 09/845,490

(22) Filed: May 1, 2001

(30) Foreign Application Priority Data
Nov. 20, 2000 (JP) 2000-352896 (P)

(51) Int. Cl. G06F 17/60

(52) U.S. Cl. 705/52

(57) ABSTRACT

An accounting method of calculating charging usage for software with no unfairness includes the steps of transmitting data inquiring a registered user of a time running the software at a processing time, receiving the running time from the user, calculating charging usage for the software used by the user by multiplying charging usage for the software per time by the received running time and an accounting rate set in correspondence to the throughput of a client computer running the software, and charging the user on the basis of the calculated charging usage.

### BACKGROUND OF THE INVENTION

1 Field of the Invention

The present invention relates to a technique of managing software, and more particularly, it relates to a technique of managing software provided from a server to a client computer through a network.

2 Description of the Prior Art

In a system including a server and a client computer connected with each other through a network, the client computer may have no application software. In this system, the client computer downloads any necessary software from the server through the network.

In this system, the server collectively charges the client computer for the software when the software is downloaded.

Japanese Patent Laying-Open No. 11-212785 (1999) discloses another method of specifically charging a client computer for downloaded software on the basis of the operating time of the software.

The method disclosed in the above gazette manages use of software between a server connected to a network for providing software download services and a client computer downloading software from the server through the network for running the software. This method includes steps of posting to the server the operating time of software downloaded from the server when the software is run on the client computer and cumulatively adding up the operating time posted from the client computer to the server.

According to this method, the operating time of the software downloaded from the server is posted to the server when the client computer runs the software. The server cumulatively adds up the operating time posted from the client computer. Every time the client computer runs software downloaded from the server, information related to the operating time of the software is transferred from the client computer to the server, to be cumulatively added up. Consequently, the server can implement specific accounting on the basis of the operating time of each software for each client computer at a constant time interval (every month, for example).

According to the specific accounting method disclosed in the aforementioned gazette, accounting is performed on the basis of only the operating time of the software. No factors other than the operating time of the software are taken into consideration, and hence the client computer may not be properly charged as to the charging usage for the software. If the software received from the server can be run on another computer regardless of the charging usage, proper accounting may not be performed as to the charging usage for the software.

### SUMMARY OF THE INVENTION

An object of the present invention is to provide a software use management server and a software use management method, which can manage software run on a client computer without striking the user of the client computer as unfair.

Another object of the present invention is to provide a software use management server and a software use management method, which can manage software run on a client computer without allowing the user of the client computer to illegally use the software.

Still another object of the present invention is to provide a software use management server and a software use management method, which can calculate charging usage in response to the contents of actual use of software.

A further object of the present invention is to provide a software use management server and a software use management method, which can calculate charging usage for software without requiring the user of a client computer to recognize the throughput of the computer.

A further object of the present invention is to provide a software use management server and a software use management method, which enables only a client computer downloading software from a server to run the software.

A server according to the present invention is a software management server managing software run on a client computer. The client computer includes a control circuit for controlling the client computer and running the software and a communication circuit for transmitting data indicating the time running the software by the control circuit to the server. The software management server includes a communication circuit for communicating with the client computer and receiving the data from the client computer, a storage circuit for storing the throughput of the client computer and charging usage for the software per time, and a calculation circuit connected to the communication circuit and the storage circuit for calculating charging usage for the software on the basis of the charging usage and the throughput stored in the storage circuit.

The server can calculate charging usage responsive to the throughput of the client computer on the basis of the data indicating the run time of the software transmitted from the client computer as well as the charging usage and the throughput stored in the storage circuit. The server can vary the charging usage with the throughput of the client computer if the software runs for the same time. In the system of receiving software from the server and running the software on the client computer, the charging usage for the software can be collected without striking the user as unfair. The software run on the client computer may be distributed from the server to the client computer through a network, distributed from the server to the client computer through a portable terminal, or stored in the client computer through a recording medium without through a network.

More preferably, the calculation circuit includes a circuit for calculating higher charging usage for the software as to a client computer having a high throughput than a client computer having a low throughput.

Higher charging usage can be calculated as to the client computer having a high throughput than the client computer having a low throughput if the software runs for the same time. Thus, the charging usage for the software can be calculated without striking the user of the client computer having a low throughput as unfair.

More preferably, the communication circuit of the client computer further includes a circuit for transmitting identification information for identifying the client computer to the server. The communication circuit of the server includes a circuit for communicating with a plurality of client computers and receiving the data and the identification information from the plurality of client computers. The storage circuit includes a circuit for storing the throughputs of the plurality of client computers and charging usage for the software per time. The calculation circuit includes a circuit for calculating charging usage for the software on the basis of the data received by the communication circuit of the server, the charging usage stored in the storage circuit and the throughput of a client computer identified by the identification information received by the communication circuit of the server.

The server can identify the throughput of a client computer running the software from the throughputs of the plurality of client computers on the basis of the identification information, transmitted from the client computer, for identifying the client computer itself. On the basis of this, the server can calculate the charging usage responsive to the throughput of the client computer.

More preferably, the software management server is a server managing software transmitted from the server and run on the client computer. The client computer further includes a storage circuit for storing unrewritable first identification information for identifying the client computer. The communication circuit of the client computer further includes a circuit for transmitting the first identification information to the server and a circuit for receiving software provided with second identification information from the server. The control circuit of the client computer includes a circuit for controlling the client computer and running the received software when the first identification information stored in the storage circuit and the second identification information provided on the software received by the communication circuit satisfy a predetermined relation. The communication circuit of the server includes a circuit for communicating with the client computer and receiving the data and the first identification information from the client computer. The storage circuit of the server further includes a circuit for storing program data for running the software on the client computer. The server further includes a control circuit for controlling the communication circuit of the server to transmit the second identification information and the program data stored in the storage circuit of the server to the client computer when the communication circuit of the server receives the first identification information.

The server transmits the software provided with the second identification information satisfying the predetermined relation (the relation that the second identification information is identical to the first identification information or the like) with the received first identification to the client computer. The client computer cannot run the software unless the first identification for identifying the client computer itself and the second identification information provided on the software satisfy the predetermined relation. Only the client computer transmitting the first identification information can run the received software, so that another computer cannot run the software even if this computer receives the software from the client computer through a recording medium. In the Ad system of receiving the software from the server for running the software in the client computer, the charging usage for the software can be collected without striking the user as unfair and the software received from the server can be prevented from illegal use. Wording “software can be run” includes a case where software stored in a storage medium such as a fixed disk can be read on a memory and run by a CPU and a case where a program for installing software stored in a storage medium such as a fixed disk can be read on a memory and run by a CPU after the software is installed. Therefore, wording “software cannot be run” includes a case where the software cannot be installed.

A software management method according to another aspect of the present invention is a software management method in a software management server managing software run on a client computer. The client computer controls the client computer for running the software, and transmits data indicating the time running the software to the server. The software management method includes steps of communicating with the client computer and receiving the data from the client computer, previously preparing the throughput of the client computer and charging usage for the software per time, and calculating charging usage for the software on the basis of the data received in the step of receiving the data and the charging usage and the throughput prepared in the step of previously preparing data.

In the step of calculating the charging usage, charging usage responsive to the throughput of the client computer can be calculated on the basis of the data indicating the run time of the software transmitted from the client computer and the prepared charging usage and throughput. The charging usage can be varied with the throughput of the client computer regardless of the run time of the software.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the appearance of a computer implementing a software distribution server according to an embodiment of the present invention;

FIG. 2 is a block diagram of the computer implementing the software distribution server;

FIG. 3 illustrates a user management table stored in a fixed disk of the software distribution server;

FIG. 4 illustrates a CPU management table stored in the fixed disk of the software distribution server;

FIG. 5 illustrates a software management table stored in the fixed disk of the software distribution server;

FIG. 6 illustrates an individual user run time management table stored in the fixed disk of the software distribution server;

FIGS. 7A to 7E illustrate communication data between the software distribution server and a client computer according to the embodiment of the present invention;

FIG. 8 is a flow chart showing download processing in the client computer according to the embodiment of the present invention;

FIG. 9 is a flow chart showing software running on the client computer according to the embodiment of the present invention;

FIG. 10 is a flow chart showing download processing in the software distribution server according to the embodiment of the present invention;

FIGS. 11 and 12 are flow charts showing accounting in the software distribution server according to the embodiment of the present invention; and

FIG. 13 is a total structural diagram showing a software distribution system according to a modification of the embodiment.

### DESCRIPTION OF THE PREFERRED EMBODIMENTS

An embodiment of the present invention is now described with reference to the drawings. In the following description and the drawings, parts identical to each other are denoted by the same reference numerals. The names and functions of the identical parts are also identical to each other. Therefore, redundant description is not repeated where appropriate.

Embodiment

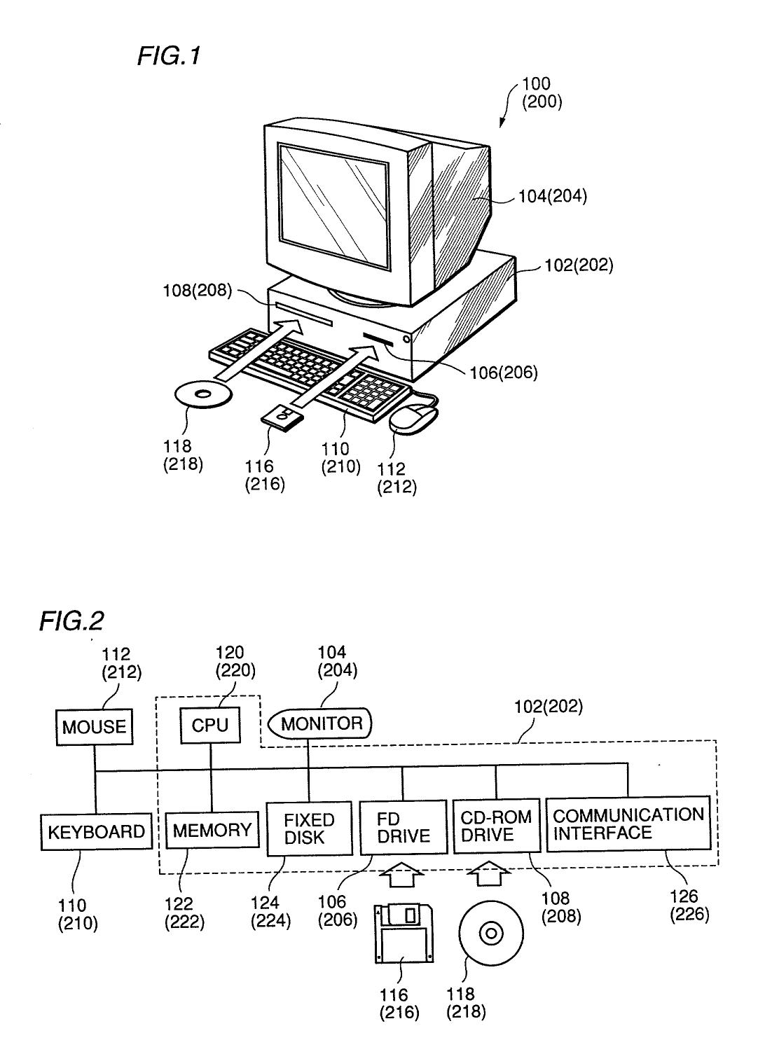

FIG. 1 illustrates the appearance of an exemplary computer system for a software distribution server 100 according to the embodiment of the present invention. Referring to FIG. 1, this computer system includes a computer 102 including an FD (flexible disk) drive 106 and a CD-ROM (compact disc-read only memory) drive 108, a monitor 104, a keyboard 110 and a mouse 112.

FIG. 2 is a block diagram showing the structure of this computer system. As shown in FIG. 2, the computer 102 includes a CPU (central processing unit) 120, a memory 122, a fixed disk 124 and a communication interface 126 for communicating with a client computer system, which are interconnected with each other by a bus, in addition to the aforementioned FD drive 106 and the aforementioned CD-ROM drive 108. An FD 116 is inserted to the FD drive 106. A CD-ROM 118 is set on the CD-ROM drive 108.

The software distribution server 100 is implemented by computer hardware and software run by the CPU 120. In general, such software is stored in a recording medium such as the FD 116 or the CD-ROM 118 to be put on the market, and read from the recording medium by the FD drive 106 or the CD-ROM drive 108, to be stored in the fixed disk 124. The software is further read from the fixed disk 124 onto the memory 122, and run by the CPU 120. The hardware of the computer 102 shown in FIGS. 1 and 2 itself is a general one. Therefore, the most essential part of the present invention resides in the software recorded in the recording medium such as the FD 116, the CD-ROM 118 or the fixed disk 124.

The operation of the computer 102 shown in FIGS. 1 and 2 itself is well known. Therefore, redundant description is not repeated.

A client computer 200 is implemented by computer hardware and the software run by the CPU 120, similarly to the software distribution server 100. Therefore, reference numerals for elements of the client computer 200 are parenthesized in FIGS. 1 and 2. Hence, redundant description is not repeated.

The fixed disk 124 of the software distribution server 100 stores CPU data such as a chip code capable of uniquely identifying the CPU 120. The CPU data is readable but not rewritable.

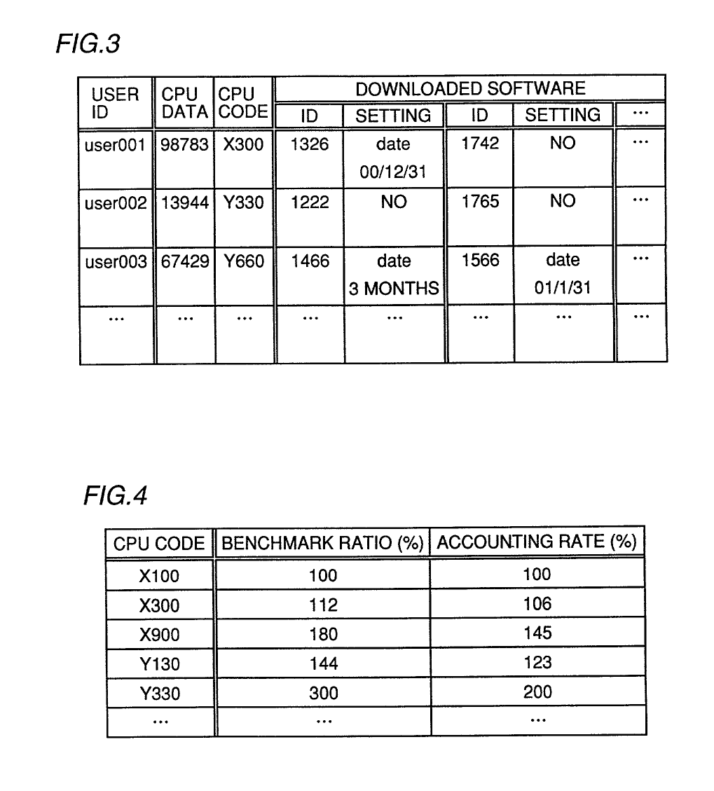

A user management table stored in the fixed disk 124 of the software distribution server 100 according to this embodiment is described with reference to FIG. 3. As shown in FIG. 3, the user management table stores user ID (identification) for uniquely identifying each user, CPU data for uniquely identifying the CPU 220 of each client computer 200, a CPU code for uniquely identifying the type of the CPU 220 of the client computer 200, and data indicating software downloaded to the client compute 200.

The data indicating the downloaded software includes an ID uniquely identifying the downloaded software and setting data for the downloaded software.

As described above, the CPU data for uniquely identifying the CPU 220 of the client computer 200 shown in FIG. 3 is stored in a fixed disk 224 of the client computer 200. The client computer 200 reads the CPU data stored in the fixed disk 224 and transmits the read CPU data to the software distribution server 100.

The setting data included in the data indicating the downloaded software is an available period for the software or the like set by the user of the client computer 200 when the client computer 200 requests downloading. For example, a user identified by a user ID “user001” sets the available period for software identified by a software ID “1326” up to Dec. 31, 2000.

A CPU management table stored in the fixed disk 124 of the software distribution server 100 is described with reference to FIG. 4. As shown in FIG. 4, the CPU management table includes a CPU code uniquely identifying the type of each CPU as well as a benchmark ratio and an accounting rate corresponding to each CPU code. As to the CPU 220 of the client computer 200 identified by a CPU code “X100”, for example, the CPU management table stores a benchmark ratio of 100% and an accounting rate of 100%. As to the CPU 220 of the client computer 200 identified by a CPU code “Y130”, the CPU management table stores a benchmark ratio of 144% and an accounting rate of 123%. When charging usage for the software is calculated as described later, a result obtained by multiplying the operating time by charging usage per unit time is multiplied by the accounting rate. The accounting rate is set to increase as the benchmark ratio increases (as the processing speed of the client computer 200 increases).

A software management table stored in the fixed disk 124 of the software distribution server 100 is described with reference to FIG. 5. As shown in FIG. 5, the software management table includes a software ID uniquely identifying each software and charging usage set for each software ID. The software management table stores charging usage per minute, for example.

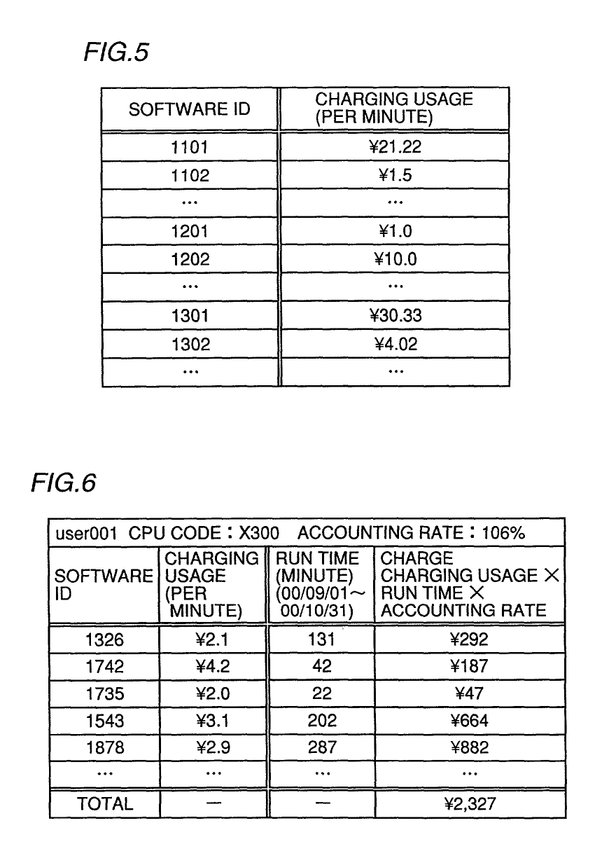

An individual user run time management table stored in the fixed disk 124 of the software distribution server 100 is described with reference to FIG. 6. As shown in FIG. 6, the individual user run time management table includes the CPU code of the client computer 200 used by each user, the accounting rate, a software ID indicating each downloaded software, software charging usage (per minute) for each software ID, a run time of each software run on the client computer 200 and charging usage for the software calculated by {charging usage per unit time×run time×accounting rate} for each user ID.

The individual user run time management table for the user identified by the user ID “user001 ”, for example, is described. As to this user, the individual user run time management table stores that the CPU code of the client computer 200 used by the user is “X300”, the accounting rate is “06%”, software identified by a software ID “1742”, for example, has been used for 42 minutes between Sep. 1, 2000 and Oct. 31, 2000, and the charging usage for this software calculated from the charging usage per unit time, the run time and the accounting rate is 187 yen.

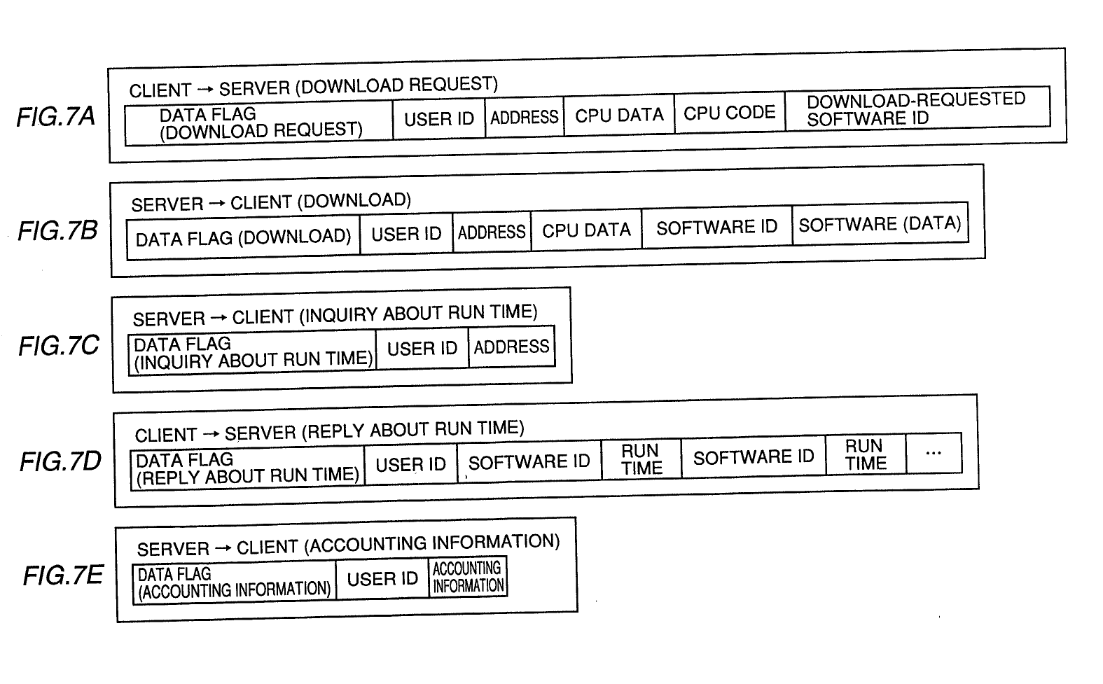

Data transferred between the software distribution server 100 and the client computer 200 according to this embodiment are described with reference to FIGS. 7A to 7E.

As shown in FIG. 7A, download request data transmitted from the client computer 200 to the software distribution server 100 includes a data flag indicating that this data is download request data, the user ID, an address, the CPU data, the CPU code and a download request software ID.

Referring to FIG. 7B, download data transmitted from the software distribution server 100 to the client computer 200 includes a data flag indicating this data is download data, the user ID, the address, the CPU data, the software ID and the software (data).

Referring to FIG. 7C, run time inquiry data transmitted from the software distribution server 100 to the client computer 200 includes a data flag indicating that this data is run time inquiry data, the user ID and the address.

Referring to FIG. 7D, run time reply data transmitted from the client computer 200 to the software distribution server 100 includes a data flag indicating that this data is run time reply data, the user ID, the software ID and the run time. This run time reply data includes a plurality of data items each consisting of combinations of software IDs and run times.

Referring to FIG. 7E, accounting information transmitted from the software distribution server 100 to the client computer 200 includes a data flag indicating that this data is accounting information data, the user ID and accounting information. The accounting information is the sum of the aforementioned charging usage shown in FIG. 6.

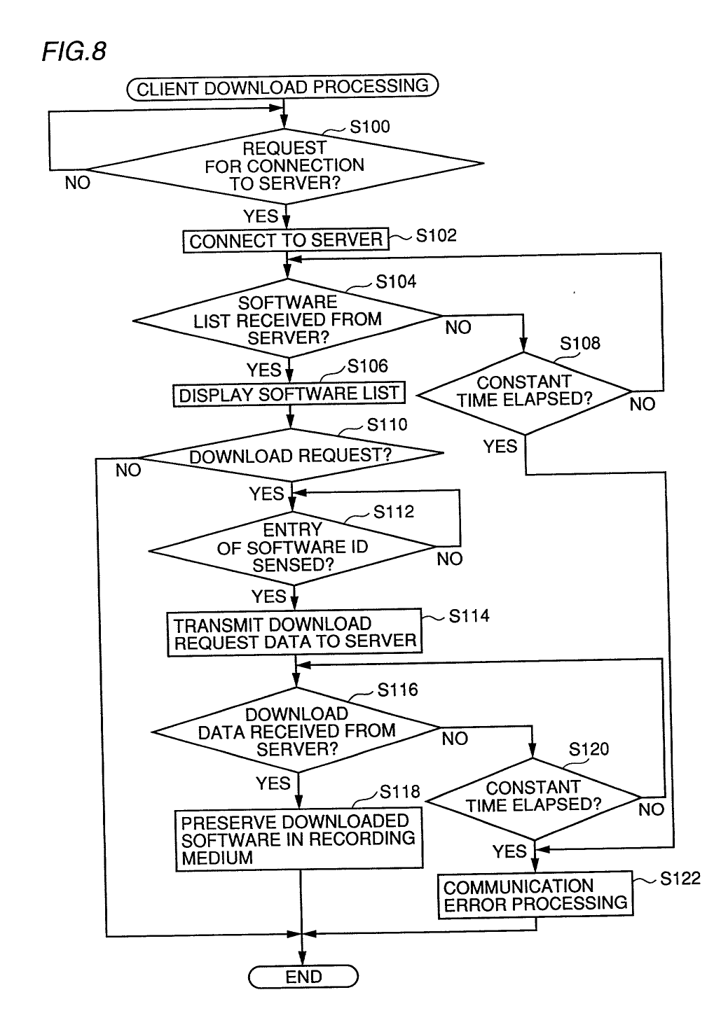

Referring to FIG. 8, a program run on the client computer 200 according to this embodiment has the following control structure in relation to download processing:

At a step (hereinafter the step is abbreviated as S) 100, the CPU 220 of the client computer 200 determines whether or not a request for connection to the software distribution server 100 is entered. This determination is made on the basis of entry through the keyboard 210 or the mouse 212. When the request for connection to the software distribution server 100 is entered (YES at S 100), the process is advanced to S 102. When no request for connection to the software distribution server 100 is entered (NO at S100), the process is returned to S100, to wait for the request for connection to the software distribution server 100.

At S 102, the CPU 220 connects the client computer 200 to the software distribution server 100 through a communication interface 226. At this time, the client computer 200 is connected to a specific site provided by the software distribution server 100. Alternatively, the client computer 200 may be connected to a specific site provided by a service provider. In this case, the client computer 200 is connected to the software distribution server 100 through the service provider, so that software (data) is downloaded to the client computer 200.

At S104, the CPU 220 determines whether or not data expressing a software list is received from the software distribution server 100. When the data expressing the software list is received from the software distribution server 100 (YES at S104), the process is advanced to S 106. When no data expressing the software list is received from the software distribution server 100 (NO at S104), the process is advanced to S108.

At S106, the CPU 220 displays the software list received at S104 on a monitor 204.

At S108, the CPU 220 determines whether or not a predetermined time has elapsed after the connection to the software distribution server 100 at S102. When the predetermined time has elapsed after the connection to the software distribution server 100 (YES at S108), the process is advanced to S 122. When the predetermined time has not yet elapsed (NO at S108), the process is returned to S104, to wait for the data expressing the software list transmitted from the software distribution server 100.

At S110, the CPU 220 determines whether or not a download request for software is sensed. This determination is made by determining whether or not the user of the client computer 200 has entered the download request. When the download request is sensed (YES at Silo), the process is advanced to S112. When no download request is sensed (NO at S110), this download processing is terminated.

At S112, the CPU 220 determines whether or not entry of the software ID is sensed. This determination is made by determining whether or not the user of the client computer 200 has entered a software ID identifying the object of the download request. When entry of the software ID is sensed (YES at S112), the process is advanced to S114. When no entry of the software ID is sensed (NO at S112), the process is returned to S 112 to wait for entry of the software ID.

At S114, the CPU 220 transmits the download request data shown in FIG. 7A to the software distribution server 100.

At S116, the CPU 220 determines whether or not the download data shown in FIG. 7B is received from the software distributions server 100. When the download data is received from the software distributions server 100 (YES at S116), the process is advanced to S118. When no download data is received from the software distribution server 100 (NO at S116), the process is advanced to S 120.

At S1 18, the CPU 220 stores the downloaded software in a recording medium along with the CPU data included in the download data. In this case, the recording medium includes the fixed disk 224 or the FD 116 stored by the FD drive 206. In this case, the downloaded software and the CPU data included in the download data are integrally stored so that the software cannot be preserved or read alone.

At S120, the CPU 220 determines whether or not a predetermined time has elapsed after transmitting the download request data to the software distribution server 100 at S114. When the predetermined time has elapsed (YES at S120) after transmitting the download request data to the software distribution server 100 (YES at S120), the process is advanced to S122. When the predetermined time has not yet elapsed (NO at S120), the process is returned to S 116 to wait for the download data transmitted from the software distribution server 100.

At S122, the CPU 220 performs communication error processing. In the communication error processing, the CPU 220 makes the monitor 204 display information on the error etc. caused in the communication with the software distribution server 100.

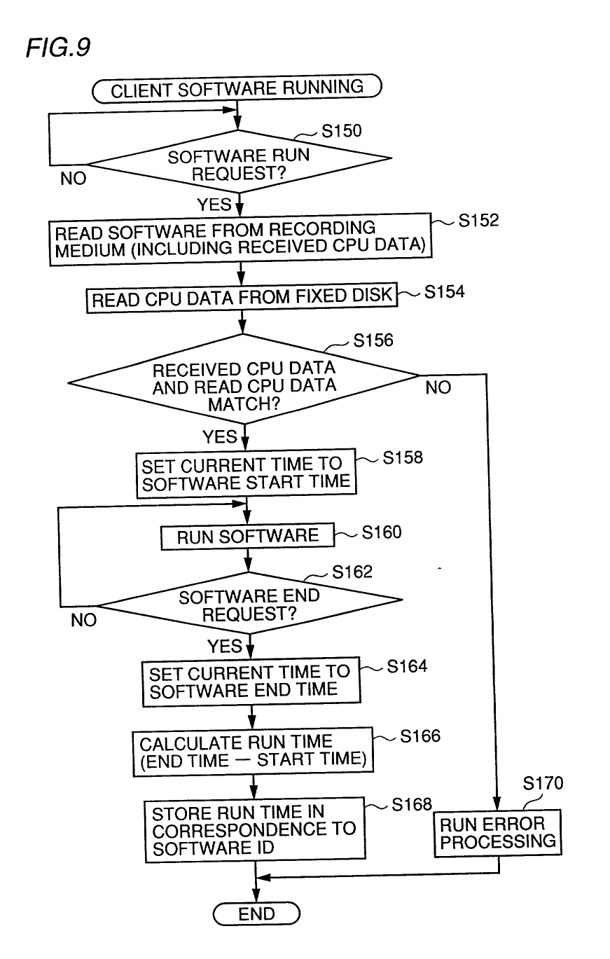

Referring to FIG. 9, the program run on the client computer 200 has the following control structure in relation to software running:

At S150, the CPU 220 of the client computer 200 determines whether or not a software run request is sensed. This determination is made by determining whether or not the user of the client computer 200 enters a software ID identifying the object of the run request. When the software run request is sensed (YES at S150), the process is advanced to S152. When no software run request is sensed (NO at S150), the process is returned to S 150, to wait for the software run request.

At S152, the CPU 220 reads the software identified at S150 from the recording medium (the fixed disk 224, an FD 216 or the like). At this time, the CPU 220 also reads the CPU data included in the download data shown in FIG. 7B.

At S154, the CPU 220 reads the CPU data for identifying the CPU 220 itself stored in the fixed disk 224.

At S156, the CPU 220 determines whether or not there is a match between the received CPU data read at S 154 and the CPU data read at S154. When there is a match (YES at 156), the process is advanced to S158. When there is no match (NO at S156), the process is advanced to S170.

At S158, the CPU 220 sets a software start time to the current time. At S160, the CPU 220 runs the software. At S162, the CPU 220 determines whether or not a software end request is sensed. When the software end request is sensed (YES at S162), the process is advanced to S164. When no software end request is sensed (NO at S162), the process is returned to 5160, to continuously run the software.

At S 164, the CPU 220 sets a software end time to the current time. At S166, the CPU 220 subtracts the software start time set at S158 from the software end time set at S164, thereby calculating the run time. At S168, the CPU 220 stores the run time calculated at S166 in the fixed disk 224 in correspondence to the software ID.

At S170, the CPU 220 performs run error processing. In the run error processing, the CPU 220 makes the monitor 204 display information as to mismatch of the received CPU data and the read CPU data or the like.

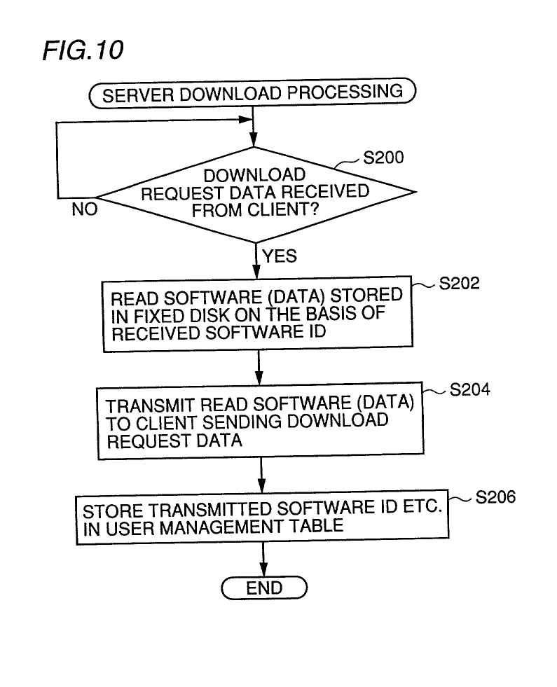

Referring to FIG. 10, a program run on the software distribution server 100 according to this embodiment has the following control structure in relation to download processing:

At S200, the CPU 120 determines whether or not the download request data shown in FIG. 7A is received from the client computer 200. When the download request data is received from the client computer 200 (YES at S200), the process is advanced to S202. When no download request data is received from the client computer 200 (NO at S200), the process is returned to S200, to wait for the download request data transmitted from the client computer 200.

At S202, the CPU 120 reads software (data) stored in the fixed disk 124 on the basis of the software ID included in the download request data received at S200. At S204, the CPU 120 transmits the software (data) read at S202 to the client computer 200 sending the download request data. The download data transmitted at this time has the data structure shown in FIG. 7B. The CPU 120 transmits the CPU data sent from the client computer 200 along with the software requested for downloading.

At S206, the CPU 120 stores the transmitted software ID etc. in the user management table shown in FIG. 3 stored in the fixed disk 124 in correspondence to the user ID indicating the destination of transmission.

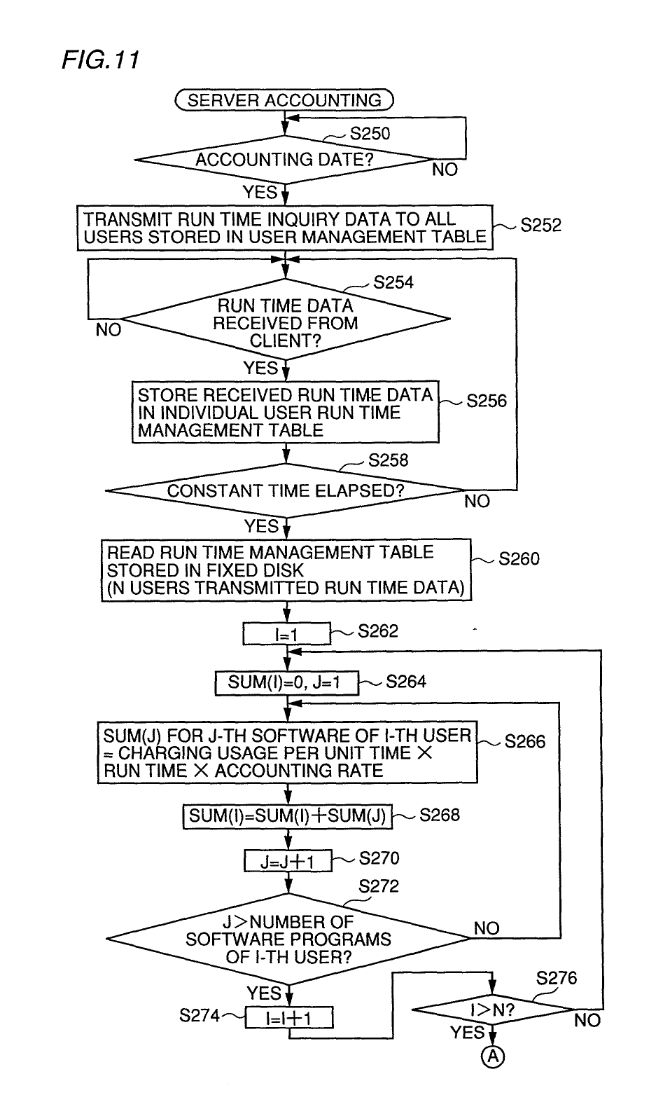

Referring to FIG. 11, the program run on the software distribution server 100 has the following control structure in relation to accounting:

At S250, the CPU 120 determines whether or not the current date is an accounting date. The accounting date is set every month (a specific time at the beginning of every month), for example. When the current date is the accounting date (YES at S250), the process is advanced to S252. When the current date is not the accounting date (NO at S250), the process is returned to S250, to wait until the accounting date.

At S252, the CPU 120 transmits the run time inquiry data shown in FIG. 7C to all users stored in the user management table shown in FIG. 3.

At S254, the CPU 120 determines whether or not the run time data shown in FIG. 7D is received from the client computer 200. When the run time data is received from the client computer 200 (YES at S254), the process is advanced to S256. When no run time data is received from the client computer 200 (NO at S254), the process is returned to S254 to wait for the run time data transmitted from the client computer 200.

At S256, the CPU 120 stores the run time data received at S254 in the individual user run time management table shown in FIG. 6. At this time, the run time data is received in the combinations of the software IDs and the run times as shown in FIG. 7D, and hence the individual user run time management table shown in FIG. 6 stores the corresponding run time on the basis of each software ID.

At S258, the CPU 120 determines whether or not a predetermined time has elapsed after transmitting the run time inquiry data at S252. When the predetermined time has elapsed (YES at S258), the process is advanced to S260. When the predetermined time has not yet elapsed (NO at S258), the process is returned to S254, to wait for the run time data transmitted from the client computer 200.

At S260, the CPU 120 reads the data from the run time management table (FIG. 6) stored in the fixed disk 124. It is assumed that N (N: natural number) users have transmitted the run time data.

At S262, the CPU 120 initializes a variable I (I=1). At S264, the CPU 120 initializes a variable J and a variable SUM(I) (J=1, SUM(I) =0).

At S266, the CPU 120 operates SUM(J)={charging usage per unit time×run time×accounting rate} for J-th software of an I-th user. At S268, the CPU 120 operates SUM(I)={SUM(I)+SUTM(J)}.

At S270, the CPU 120 adds 1 to the variable J. At S272, the CPU 120 determines whether or not the variable J is greater than the number of software programs for the I-th user. When the variable J is greater than the number of software programs for the I-th user (YES at S272), the process is advanced to S274. When the variable J is less than the number of software programs for the I-th user (NO at S272), the process is returned to S266, for calculating charging usage for the next software of this user and adding the calculated charging usage to the total charging usage.

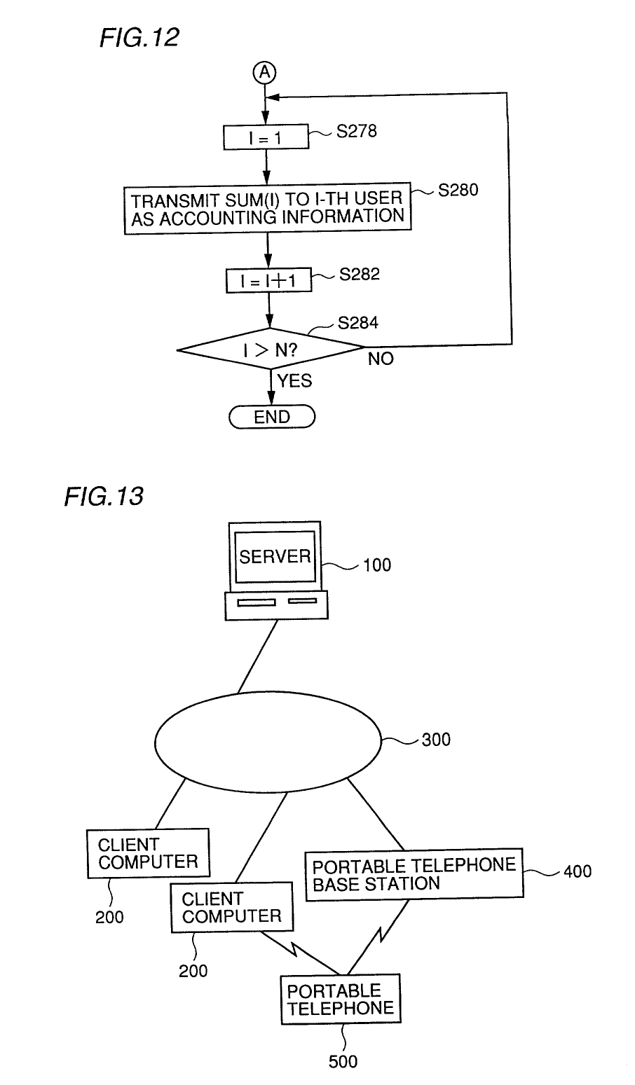

At S274, the CPU 120 adds 1 to the variable I. At S276, the CPU 120 determines whether or not the variable I is greater than the number N of the users. When the variable I is greater than the number N of the users (YES at S276), the process is advanced to S278 shown in FIG. 12. When the variable I is less than or equal to the number N of the users (NO at S276), the process is returned to S264, for calculating total charging usage for the next user.

Referring to FIG. 12, the CPU 120 initializes the variable I (I=1) at S278. At S280, the CPU 120 transmits accounting information data having accounting information of the total charging usage SUM(I) to the I-th user (FIG. 7E). At S282, the CPU 120 adds 1 to the variable I. At S284, the CPU 120 determines whether or not the variable I is greater than the number N of the users. When the variable I is greater than the number N of the users (YES at S284), this accounting is terminated. When the variable I is less than or equal to the number N of the users (NO at S284), the process is returned to S278, for transmitting accounting information data as to the next user. In the client computer 200 receiving the accounting information data shown in FIG. 7, the user enters the personal identification number of his credit card on the basis of the accounting information indicating the charging usage included in the accounting information data for settling the account, and the accounting is terminated.

Operations of the software distribution server 100 and the client computer 200 based on the aforementioned structures and flow charts are now described.

[Download Operation]

When the user issues a request for connection to the software distribution server 100 through the keyboard 210 or the mouse 212 of the client computer 200 (YES at S100), the client computer 200 is connected to the software distribution server 100 (S102). The software distribution server 100 transmits data capable of displaying a list of the software programs stored in the software distribution server 100 to the client computer 200.

When the client computer 200 receives the data capable of displaying the software list from the software distribution server 100 (YES at S104), the monitor 204 of the client computer 200 displays the list of the software programs stored in the software distribution server 100 (S106). At this time, the monitor 204 displays the software IDs uniquely identifying the software programs.

When the user of the client computer 200 issues a download request through the keyboard 210 or the mouse 212 according to the contents of the monitor 204 (YES at S110) and enters a software ID (YES at S112), the client computer 200 transmits the download request data shown in FIG. 7A to the software distribution server 100 (S114).

The software distribution server 100 receiving the download request data from the client computer 200 reads the software (data) stored in the fixed disk 124 on the basis of the software ID included in the received download request data (S202). The read software (data) is transmitted to the client computer 200 sending the download request data along with the CPU data included in the download request data (S204). The software distribution server 100 stores the transmitted user ID, software ID and the like in the user management table shown in FIG. 3 (S206).

The client computer 200 receiving the download data from the software distribution server 100 stores the downloaded software in the recording medium (the fixed disk 224 or the FD 216) (S118).

When a predetermined time elapses (YES at S108) without receiving the software list after the client computer 200 is connected to the software distribution server 100 (S102) in the download operation, the control advances to S122. When the predetermined time elapses (YES at S120) without receiving the download data after the client computer 200 transmits the download request data to the software distribution server 100 (S114), the control advances to S122. At S122, communication error processing is performed on the assumption that an error takes place in the communication between the software distribution server 100 and the client computer 200.

[Software Running Operation]

When the user issues a software run request (YES at s150) through the keyboard 210 or the mouse 212 in the client computer 200 storing the software downloaded from the software distribution server 100 in the fixed disk 224 or in the client computer 200 having the FD 216, set on the FD drive 206, storing the software downloaded from the software distribution server 100, the software is read from the recording medium (S 152). The CPU data received from the software distribution server 100, stored in the recording medium, is also read at this time. After the software is read from the recording medium, the CPU data uniquely identifying the CPU 220 stored in the fixed disk 224 is read (S154).

When there is a match between the received CPU data and the read CPU data (YES at S156), the software start time is set to the current time (S158). When the user enters an end request for the software in running (YES at S162), the software end time is set to the current time (S164). The run time is calculated by subtracting the software start time from the software end time (S166), so that the calculated run time is stored in the fixed disk 224 of the client computer 200 along with the software ID identifying the run software (S168).

When there is no match between the received CPU data and the read CPU data (NO at S156), the software downloaded from the software distribution server 100 is not run but run error processing is performed (S170).

[Accounting Operation]

On the accounting date (YES at S250), the software distribution server 100 transmits the run time inquiry data shown in FIG. 7C to all users stored in the user management table shown in FIG. 3 (S252). When the run time data shown in FIG. 7D is received from the client computer 200 (YES at S254) before the predetermined time elapses after transmitting the run time inquiry data (NO at S258), the individual user run time management table shown in FIG. 6 stores the received run time data (S256).

When the predetermined time elapses after transmitting the run time inquiry data (YES at S258), the data are read from the run time management table stored in the fixed disk 124 (S260).

As to the first software of the first user, {charging usage per unit time (per minute, for example)×run time×accounting rate} is calculated for calculating total software charging usage. Then, {charging usage per unit time (per minute, for example)×run time×accounting rate} is calculated as to the second software of the first user, and the result is added to the charging usage for the first software. Such processing is repeated until the variable J exceeds the number of the software programs used by the first user (YES at S272), and the total charging usage for a plurality of software programs used by the first user is substituted in a variable SUTM(l). Such processing is repeated for all users transmitting the run time data, for calculating total software charging usage corresponding to each user. At this time, the accounting rate is set in correspondence to the CPU code for the client compute 200 used by each user. As described above, the accounting rate is set to increase in proportion to the throughput of the CPU 220 (FIG. 4). Therefore, a higher accounting rate is set for a user using the client computer 200 including the CPU 220 having a higher throughput, so that relatively high charging usage is calculated for a small operating time.

When the charging usage for the software programs is completely calculated as to all users, the total software charging usage SUM(1) is transmitted to the first user as the accounting information (S280). At this time, the data shown in FIG. 7E is transmitted as the accounting information data. Such processing is repeated for all users transmitting the run time data.

In the client computer 200 receiving the accounting information data shown in FIG. 7E, the user of the client computer 200 enters the personal identification number of his credit card to pay for the total software charging usage with the credit card, and the accounting operation is terminated.

In the software distribution server and the client computer according to the present invention, as hereinabove described, the client computer transmits the run time of each software to the software distribution server, which in turn calculates the software charging usage on the basis of the received run time of the software and the accounting rate corresponding to the throughput of the client computer. When the client computer downloads the software, the software distribution server appends the CPU data capable of uniquely identifying the CPU of the client computer to the downloaded software. The client computer can run the software only when the CPU data appended to the received software matches with the CPU data of the client computer itself. Consequently, a software distribution server and a client computer capable of collecting software charging usage without striking the user as unfair also when the throughput of the client computer used by the user is different from those of other client computers and preventing the software received from the server from illegal use can be provided in the system of the server and the client computer receiving the software from the server and running the software.

The following processing may be added to the processing at S156 according to the embodiment shown in FIG. 9. On the basis of the setting data for each downloaded software stored in the user management table of the software distribution server 100, the software distribution server 100 transmits the set contents to the client computer 200, so that the client computer 200 performs the processing of S158 or S170 in response to the set contents. When the available period is set as shown in FIG. 3, the current date is compared with the set period. The processing of S158 to S168 is performed when the current date is before the available period. The processing of S170 is performed when the current date is after the available period.

Modification

A modification of the software distribution system according to the embodiment of the present invention is now described. The aforementioned software distribution system distributes software to the client computer 200 from the software distribution server 100 shown in FIG. 13 through a network 300.

In a software distribution system according to this modification, on the other hand, the software distribution server 100 temporarily distributes software to a portable telephone 500 through the network 300 and a portable telephone base station 400. The portable telephone 500 transmits the received software to the client computer 200 through radio communication or wire communication. The client computer 200 receiving the software from the portable telephone 500 operates as described above.

In the software distribution system according to this modification, the portable telephone 500 stores the CPU data of the client computer 200 running the downloaded software. The portable telephone 500 transmits download request data including the stored CPU data to the software distribution server 100, and downloads the software including the CPU data from the software distribution server 100. The portable telephone 500 transmits the downloaded software and CPU data to the client computer 200. The client computer 200 can run the software downloaded through the portable telephone 500 when the CPU data received from the portable telephone 500 along with the software matches with the CPU data stored in the fixed disk 224 thereof.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A software management server managing software run on a client computer, said client computer including control means for controlling said client computer and running said software and communication means for transmitting data indicating the time running said software by said control means to said server,
said software management server comprising:
communication means for communicating with said client computer and receiving said data from said client computer;
storage means for storing the throughput of said client computer and charging usage for said software per time; and
calculation means connected to said communication means and said storage means for calculating charging usage for said software on the basis of said data received by said communication means of said server as well as said charging usage and said throughput stored in said storage means.

2. The software management server according to claim 1, wherein said calculation means includes means connected to said communication means and said storage means for calculating charging usage for said software so that a client computer having a high throughput is charged higher than a client computer having a low throughput.

3. The software management server according to claim 1, wherein said communication means of said client computer further includes means for transmitting identification information for identifying run software to said server,
said communication means of said server includes means for communicating with said client computer and receiving said data and said identification information from said client computer,
said storage means includes means for storing the throughout of said client computer and charging usage for a plurality of software programs per time, and
said calculation means includes means for calculating charging usage for said software on the basis of said data received by said communication means of said server, charging usage for software identified by said identification information received by said communication means of said server and said throughput stored in said storage means.

4. The software management server according to claim 1, wherein said communication means of said client computer further includes means for transmitting identification information for identifying said client computer to said server,
said communication means of said server includes means for communicating with a plurality of client computers and receiving said data and said identification information from said plurality of client computers,
said storage means includes means for storing the throughputs of said plurality of client computers and charging usage for said software per time, and
said calculation means includes means for calculating charging usage for said software on the basis of said data received by said communication means of said server, said charging usage stored in said storage means and the throughput of a client computer identified by said identification information received by said communication means of said server.

5. The software management server according to claim 1, wherein said communication means of said client computer further includes means for transmitting first identification information for identifying run software to said server and means for transmitting second identification information for identifying said client computer to said server,
said communication means of said server includes means for communicating with a plurality of client computers and receiving said data, said first identification information and said second identification information from said plurality of client computers,
said storage means includes means for storing the throughputs of said plurality of client computers and charging usage for a plurality of software programs per time, and
said calculation means includes means for calculating charging usage for said software on the basis of said data received by said communication means of said server, charging usage for software identified by said first identification information received by said communication means of said server and the throughput of a client computer identified by said second identification information received by said communication means of said server.

6. The software management server according to claim 1, wherein said software management server is a server managing software transmitted from said server and run on said client computer,
said client computer further includes storage means for storing unrewritable first identification information for identifying said client computer itself, said communication means of said client computer further includes means for transmitting said first identification information to said server and means for receiving said software provided with second identification information from said server, and said control means of said client computer includes means for controlling said client computer and running received said software when said first identification information stored in said storage means and said second identification information provided on said software received by said communication means satisfy a predetermined relation,
said communication means of said server includes means for communicating with said client computer and receiving said data and said first identification information from said client computer,
said storage means of said server further includes means for storing program data for running said software on said client computer, and
said server further includes control means for controlling said communication means of said server to transmit said second identification information and said program data stored in said storage means of said server to said client computer when said communication means of said server receives said first identification information.

7. The software management server according to claim 1, wherein said server further includes collection means for collecting a charge from said client computer on the basis of said calculated charging usage.

8. A software management server managing software run on a client computer, wherein
said client computer includes a control circuit controlling said client computer for running said software and a communication circuit transmitting data indicating the time running said software by said control circuit to said server, and
said software management server includes:
a communication circuit communicating with said client computer and receiving said data from said client computer;
a storage circuit storing the throughput of said client computer and charging usage for said software per time; and
a calculation circuit connected to said communication circuit and said storage circuit for calculating charging usage for said software on the basis of said data received by said communication circuit of said server as well as said charging usage and said throughput stored in said storage circuit.

9. The software management server according to claim 8, wherein said calculation circuit includes a circuit connected to said communication circuit and said storage circuit for calculating charging usage for said software so that a client computer having a high throughput is charged higher than a client computer having a low throughput.

10. The software management server according to claim 8, wherein said communication circuit of said client computer further includes a circuit transmitting identification information for identifying run software to said server,
said communication circuit of said server includes a circuit communicating with said client computer and receiving said data and said identification information from said client computer,
said storage circuit includes a circuit storing the throughout of said client computer and charging usage for a plurality of software programs per time, and
said calculation circuit includes a circuit calculating charging usage for said software on the basis of said data received by said communication circuit of said server, charging usage for software identified by said identification information received by said communication circuit of said server and said throughput stored in said storage circuit.

11. The software management server according to claim 8, wherein said communication circuit of said client computer further includes a circuit transmitting identification information for identifying said client computer to said server,
said communication circuit of said server includes a circuit communicating with a plurality of client computers and receiving said data and said identification information from said plurality of client computers,
said storage circuit includes a circuit storing the throughputs of said plurality of client computers and charging usage for said software per time, and
said calculation circuit includes a circuit calculating charging usage for said software on the basis of said data received by said communication circuit of said server, said charging usage stored in said storage circuit and the throughput of a client computer identified by said identification information received by said communication circuit of said server.

12. The software management server according to claim 8, wherein said communication circuit of said client computer further includes a circuit transmitting first identification information for identifying run software to said server and a circuit transmitting second identification information for identifying said client computer to said server,
said communication circuit of said server includes a circuit communicating with a plurality of client computers and receiving said data, said first identification information and said second identification information from said plurality of client computers,
said storage circuit includes a circuit storing the throughputs of said plurality of client computers and charging usage for a plurality of software programs per time, and
said calculation circuit includes a circuit calculating charging usage for said software on the basis of said data received by said communication circuit of said server, charging usage for software identified by said first identification information received by said communication circuit of said server and the throughput of a client computer identified by said second identification information received by said communication circuit of said server.

13. The software management server according to claim 8, wherein said software management server is a server managing software transmitted from said server and run on said client computer,
said client computer further includes a storage circuit storing unrewritable first identification information for identifying said client computer itself, said communication circuit of said client computer further includes a circuit transmitting said first identification information to said server and a circuit receiving said software provided with second identification information from said server, and said control circuit of said client computer includes a circuit controlling said client computer and running received said software when said first identification information stored in said storage circuit and said second identification information provided on said software received by said communication circuit satisfy a predetermined relation,
said communication circuit of said server includes circuit communicating with said client computer and receiving said data and said first identification information from said client computer,
said storage circuit of said server further includes a circuit storing program data for running said software in said client computer, and
said server further includes a control circuit controlling said communication circuit of said server to transmit said second identification information and said program data stored in said storage circuit of said server to said client computer when said communication circuit of said server receives said first identification information.

14. The software management server according to claim 8, wherein said server further includes a collection circuit collecting a charge from said client computer on the basis of said calculated charging usage.

15. A software management method in a software management server managing software run on a client computer,
said client computer controlling said client computer for running said software and transmitting data indicating the time running said software to said server,
said software management method including the steps of:
communicating with said client computer and receiving said data from said client computer;
preparing the throughput of said client computer and charging usage for said software per time; and
calculating charging usage for said software on the basis of said data received in said step of receiving said data and said charging usage and said throughput prepared in said step of preparing data.

16. The software management method according to claim 15, wherein said step of calculating charging usage includes a step of calculating charging usage for said software so that a client computer having a high throughput is charged higher than a client computer having a low throughput.

17. The software management method according to claim 15, wherein said client computer transmits identification information for identifying run software to said server,
said step of receiving said data includes a step of receiving said data and said identification information from said client computer,
said step of preparing data includes a step of preparing the throughput of said client computer and charging usage for a plurality of software programs per time, and
said step of calculating charging usage includes a step of calculating charging usage for said software on the basis of said data received in said step of receiving said data, charging usage for software identified by said identification information received in said step of receiving said data and said throughput prepared in said step of preparing data.

18. The software management method according to claim 15, wherein said client computer transmits identification information for identifying said client computer to said server,
said step of receiving said data includes a step of communicating with a plurality of client computers and receiving said data and said identification information from said plurality of client computers,
said step of previously preparing data includes a step of previously preparing the throughputs of said plurality of client computers and charging usage for said software per time, and
said step of calculating charging usage includes a step of calculating charging usage for said software on the basis of said data received in said step of receiving said data, said charging usage prepared in said step of previously preparing data and the throughput of a client computer identified by said identification information received in said step of receiving said data.

19. The software management method according to claim 15, wherein said client computer transmits first identification information for identifying run software and second identification information for identifying said client computer to said server,
said step of receiving said data includes a step of communicating with a plurality of client computers and receiving said data, said first identification information and said second identification information from said plurality of client computers,
said step of preparing data includes a step of preparing the throughputs of said plurality of client computers and charging usage for a plurality of software programs per time, and
said step of calculating charging usage includes a step of calculating charging usage for said software on the basis of said data received in said step of receiving said data, charging usage for software identified by said first identification information received in said step of receiving said data and the throughput of a client computer identified by said second identification information received in said step of receiving said data.

20. The software management method according to claim 15, in a software management server managing software transmitted from a server and run by a client computer, wherein
said client computer stores unrewritable first identification information for identifying said client computer itself, transmits said first identification information to said server, receives said software provided with second identification from said server, and runs received said software when stored said first identification information and said second identification information provided on said received software satisfy a predetermined relation,
said step of receiving said data includes a step of communicating with said client computer and receiving said data and said first identification information from said client computer, and
said step of preparing data includes a step of preparing program data for running said software in said client computer,
said software management information method further including a step of transmitting said program data prepared in said step of preparing data to said client computer along with said second identification information when said first identification information is received in said step of receiving said data.
